(19) United States
(12) Patent Application Publication
(10) Pub. No.: US 2016/0102839 A1
(43) Pub. Date: Apr. 14, 2016

(54) MODULE HIGH-BAY LIGHTING SYSTEMS AND METHODS OF PROVIDING LIGHTING

(71) Applicant: DURACOMM CORPORATION, KANSAS CITY, MO (US)

(72) Inventor: COREY BARKHURST, HARRISONVILLE, MO (US)

(21) Appl. No.: 14/882,649

(22) Filed: Oct. 14, 2015

Related U.S. Application Data
(60) Provisional application No. 62/063,563, filed on Oct. 14, 2014.
(60) Provisional application No. 62/067,175, filed on Oct. 22, 2014.

(51) Int. Cl. F21V 7/00; F21V 21/005; F21V 29/70

(52) U.S. Cl. CPC F21V 7/00; F21V 29/70; F21V 21/005

(57) ABSTRACT

A module high-bay lighting system and method of providing lighting is provided. The system includes module lighting fixtures that are electrically independent of each other but are configured to be selectively coupled to each other, such as by coupling the lighting fixtures together to form one or more run of lighting fixtures of various lengths. A run of lighting fixtures can be used independently or can be combined with additional lighting fixtures and/or additional runs of lighting fixtures so as to accommodate a variety of lighting requirements. Because each lighting fixture is electrically independent of each of the other lighting fixtures, the electrical requirements of each lighting fixture allows the lighting fixture to be categorized in a second class of lighting fixtures, certification testing for the second class of lighting fixtures being less extensive than certification testing for a first class of lighting fixtures.

### CROSS-REFERENCE TO RELATED APPLICATIONS

This application claims priority pursuant to 35 U.S.C. 119(e) to co-pending U.S. Provisional Patent Application Ser. Nos. 62/063,563, filed Oct. 14, 2014, and 62/067,175, filed Oct. 22, 2014, the entire disclosures of which are incorporated herein by reference.

### FIELD OF THE INVENTION

The present invention relates generally to high-bay lighting systems. More specifically, the present invention is concerned with unique high-bay light fixtures that are capable of being joined together to provide evenly dispersed lighting over a large area.

### BACKGROUND OF THE INVENTION

Existing high-bay lighting systems employ a plurality of large light fixtures spaced across a large area. Each light fixture includes a large light source that draws a significant amount of power and generates a significant amount of heat. Because the light source draws so much power, the light fixture must go through a rigorous certification process. In addition, because the light source generates so much heat, most light fixtures include a cumbersome heat sink. Both of these requirements increase the cost of a high-bay lighting system. Moreover, high-bay light fixtures of the prior art generally are constructed to output a predetermined amount of power. If a higher or lower power output is desired, a new design is required. Consequently, it would be beneficial to decrease the cost of high-bay lighting systems by utilizing smaller light sources so that a less rigorous certification process is required and so that a less cumbersome heat sink can be used. In addition, it would be beneficial to provide a high-bay lighting system that is capable of utilizing multiple power output amounts without requiring a newly designed fixture.

Furthermore, to maximize light being received at a target area from prior art high-bay lighting systems, each light fixture typically includes a reflector surrounding the light source and directing light downwards and outwards such that light from adjacent light fixtures mixes together as it travels away from the light sources. In this way, lighting systems of the prior art attempt to minimize bright spots and dark spots at the target area. Unfortunately, this process provides mixed results at best. For instance, decreasing dark spots in one area may increase bright spots in another area. Alternatively, or additionally, decreasing dark spots in one area using high-bay lighting systems of the prior art may require adding a light fixture to an area where much of the light being emitted from the light source shines on an area that is not required or desired to be lighted. Such situations are not only an annoyance, they also waste energy. Consequently, it would be beneficial to have a high-bay lighting system that is capable of quickly and easily being used to provide relatively even lighting to a target area without wasting energy by providing excess lighting to other areas.

### SUMMARY OF THE INVENTION

The present invention comprises a system and method for lighting a target area using one or more unique, modular, high-bay light fixtures. An embodiment of the modular lighting system of the present invention includes a plurality of modular light fixtures. An embodiment of the method of lighting a target area using the system of the present invention includes coupling a plurality of modular light fixtures together, until the desired power, size and/or shape is achieved, and positioning the lighting system such that light emitting from the modular lighting system is directed towards the target area. In many cases, this involves positioning the lighting system above the target area.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1A is a bottom perspective view of a light fixture of the present invention.

FIG. 1B is a bottom perspective view of a first run of light fixtures of the present invention, the first run including two light fixtures.

FIG. 1C is a bottom perspective view of a first run of light fixtures of the present invention, the first run including three light fixtures.

FIG. 1D is a bottom perspective view of a first run of light fixtures of the present invention, the first run including four light fixtures.

FIG. 1E is a bottom perspective view of first and second runs of light fixtures coupled together, each run including three light fixtures.

FIG. 2A is a bottom view of the light fixture of FIG. 1A.

FIG. 2B is a top view of the light fixture of FIG. 1A.

FIG. 2C is a first end view of the light fixture of FIG. 1A.

FIG. 2D is a second end view of the light fixture of FIG. 1A.

FIG. 2E is a third end view of the light fixture of FIG. 1A.

FIG. 2F is a fourth end view of the light fixture of FIG. 1A.

FIG. 3A is an exploded top perspective view of the light fixture of FIG. 1A.

FIG. 3B is an exploded bottom perspective view of the light fixture of FIG. 1A.

### DETAILED DESCRIPTION OF A PREFERRED EMBODIMENT

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

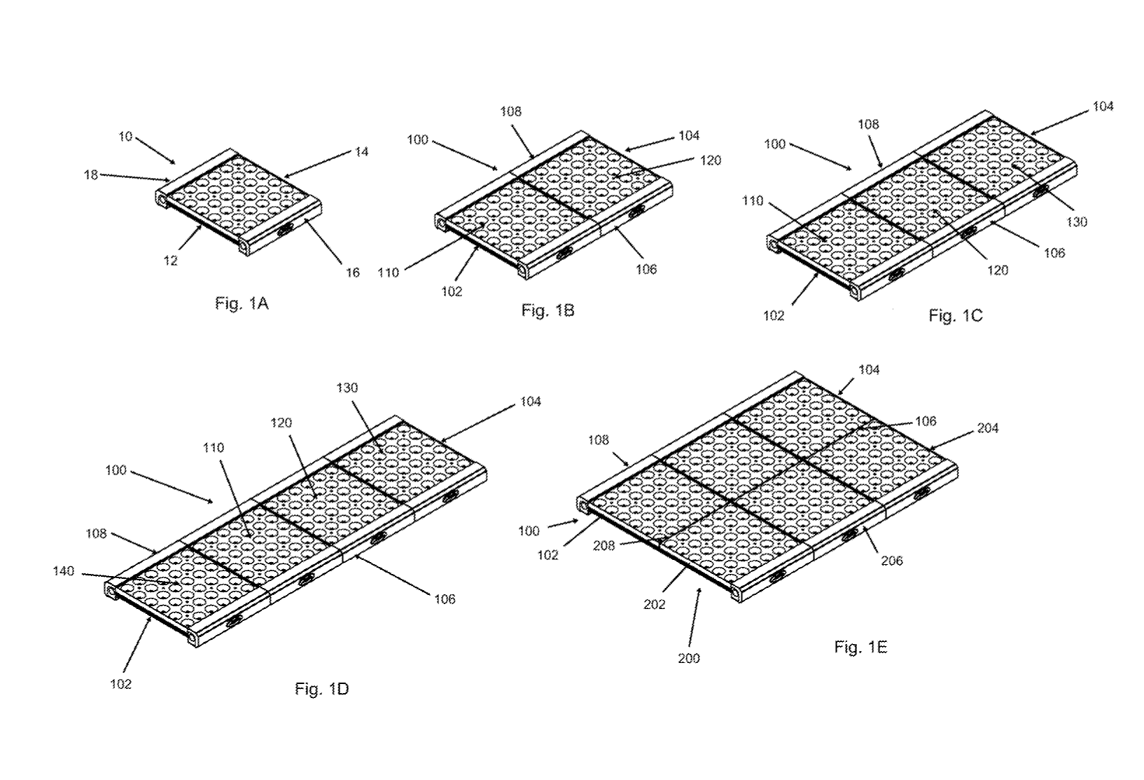

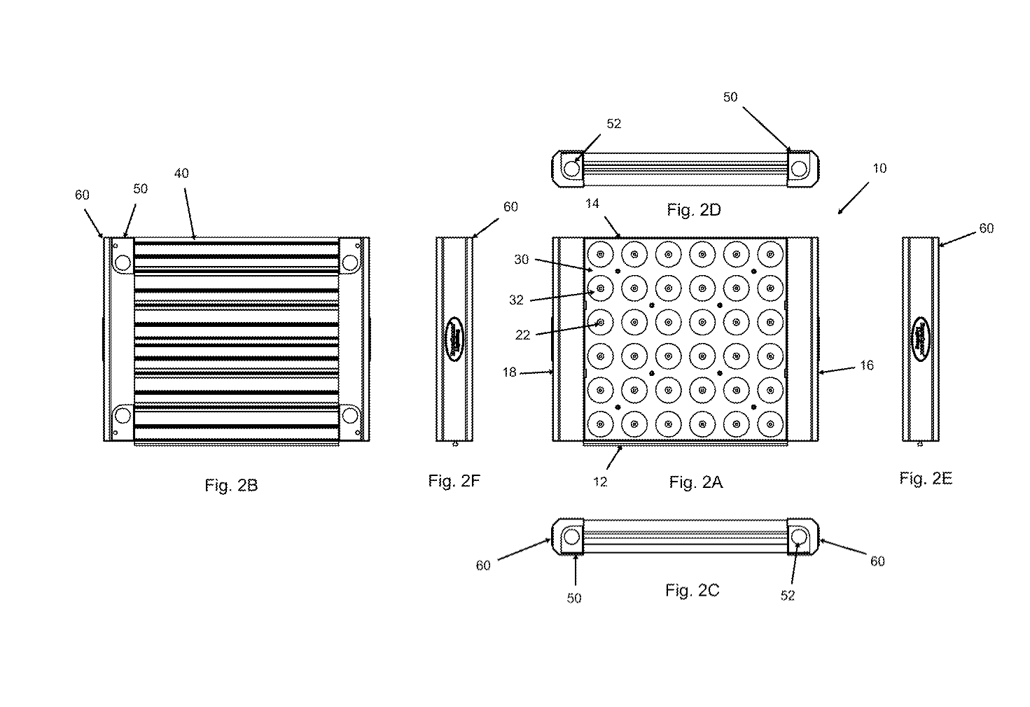

Referring to FIG. 1, some embodiments of each light fixture 10 includes opposed first 12 and second 14 ends and opposed third 16 and fourth 18 ends extending between opposed first 12 and second 14 ends. The first end 12 of each modular light fixture 10 is configured to selectively couple to the second end 14 of every other modular light fixture 10. Similarly, in some embodiments, the third 16 end of each modular light fixture 10 is configured to selectively couple to the fourth end 18 of every other modular light fixture 10. In some embodiments, a separate connecting member (not shown) is attached between the third end 16 of one fixture and the fourth end 18 of the other fixture to enable coupling. In other embodiments, the third end 16 of one fixture is positioned adjacent to the fourth end 18 of another fixture without being coupled. In some such embodiments, the adjacent fixtures are held in position adjacent to one another by an external framework (not shown) in which the modules are positioned.

Referring to FIGS. 1B-1E, coupling a plurality of modular light fixtures together enables a user to create a variety of lighting systems to meet a variety of lighting needs. For instance, referring to FIG. 1B, coupling a second end of a first light fixture 110 to a first end of a second light fixture 120 enables a user to quickly and easily create a first run 100 of light fixtures having a first edge 102, a second edge 104, a third edge 106, and a fourth edge 108. The first 102 and second 104 edges of the first run 100, being the first end of the first light fixture 110 and the second end of the second light fixture 120, respectively. Referring to FIG. 1C, coupling another light fixture 130 to either the first 102 or second 104 edge of the first run 100, increases the length and power output of the first run. Referring to FIG. 1D, coupling yet another light fixture 140 to the first run 100 further increases the length and power output of the first run 100. In this way, a user can create an ideal high-bay lighting system over a long distance, such as over an aisle, or of a desired power value, by coupling a plurality of light fixtures together to increase the length and power output of the first run 100 of light fixtures to a desired length or power output.

In some embodiments, the third 106 and fourth 108 edges of the first run 100 of light fixtures are defined by the third and fourth ends, respectively, of each light fixture 110, 120 in the first run 100 of light fixtures. Consequently, in some such embodiments, and as shown in FIG. 1E, the third edge 106 of the first run 100 of light fixtures is configured to couple to a fourth edge 208 of a second run 200 of light fixtures. In this way, a user can couple the first 100 and second 200 runs of light fixtures together so as to create an ideal high-bay lighting system over a large area, such as over a work area. In other embodiments, a separate connecting member (not shown) is attached between the third end of one fixture and the fourth end of the other fixture to enable coupling. In other embodiments, the third end of one fixture is positioned adjacent to the fourth end of another fixture without being coupled. In some such embodiments, the adjacent fixtures are held in position adjacent to one another by an external framework (not shown) in which the modules are positioned. In some embodiments, instead of adjoining first 100 and second 200 runs of light fixtures together, a first run of fixtures is designed to be the same size as the combined first and second runs.

In some embodiments, the first 102 and second 104 edges of the first run 100 of light fixtures are even with respective first 202 and second 204 edges of the second run 200 of light fixtures such that the entire system defines a quadrilateral shape so as to accommodate providing relatively even lighting throughout a standard room. In other embodiments, the first 102 and/or second 104 edge of the first run 100 of light fixtures is offset from its respective first 202 or second 204 edge of the second run 200 of light fixtures so as to accommodate additional and/or different lighting requirements. In still other embodiments, one or more lighting fixture and/or one or more run of lighting fixtures is coupled to the fourth edge 108 of the first run 100 of light fixtures and/or to a third edge 206 of the second run 200 of lighting fixtures so as to further accommodate additional and/or different lighting requirements.

It will be appreciated that the lighting fixtures in some embodiments are capable of being combined in a variety of other configurations beyond those described herein or shown in the drawings. Consequently, the versatility of the modular light fixtures of the present invention allows a user to quickly and easily provide relatively even lighting to a target area without wasting energy by providing excess lighting to other areas.

Some embodiments of the module lighting system of the present invention include end caps 50 coupled to one or more ends of each lighting fixture. For instance, in a single-run lighting system, an end cap 50 is coupled to a third and fourth end of each light fixture in the lighting system. As another example, in a double-run lighting system, an end cap 50 is coupled to a fourth end of each light fixture in a first run 100 and to a third end of each light fixture in a second run 200. In some such embodiments, the end caps 50 prevent additional light fixtures from being coupled to the third edge 206 of the second run 200 and/or the fourth edge 108 of the first run 100 of the lighting system.

In some embodiments, each end cap 50 defines an interior area 56. In some such embodiments each end cap 50 also defines a front aperture 52 and a rear aperture 54 such that when two or more end caps are positioned in line with each other, the plurality of end cap interior areas 56 define a raceway that is configured to receive electrical wires. In this way, power can be supplied from a central power source directly to each individual lighting fixture. In some such embodiments, an end cap cover 60 is coupled to each end cap 50 so as to cover the individual interior areas 56 of each end cap 50, thereby concealing the raceway from view.

In some embodiments, power from a central power source (not shown) is received by a power converter 70 coupled to each light fixture 10. The power converter converts the central power supply into a power supply that is appropriate for the individual light fixture. In some embodiments, the power converter 70 is positioned within an interior area 56 of an end cap 50. In some such embodiments, an end cap cover 60 is coupled to each end cap 50 so as to cover the interior area 56 of the end cap 50, thereby concealing the power converter 70 from view.

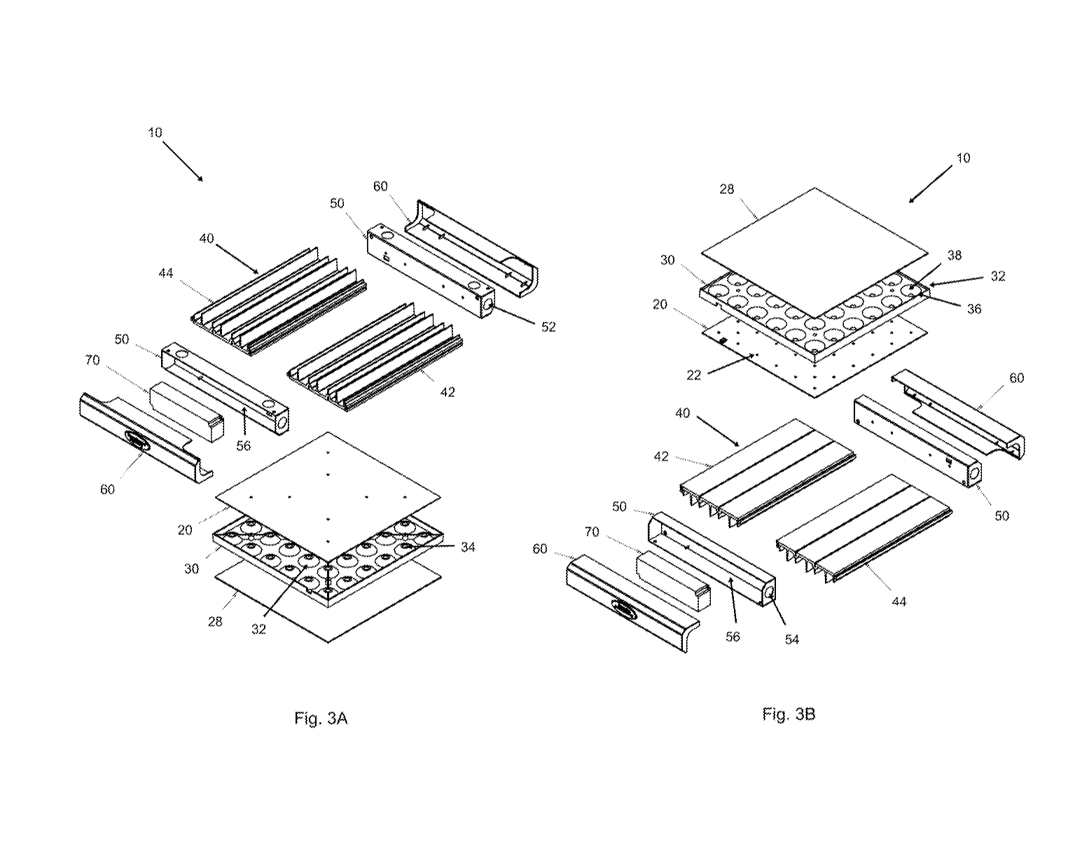

In some embodiments, each high-bay light fixture 10 includes a plurality of light sources 22. As shown in FIGS. 3A and 3B, some embodiments of a light fixture include a reflector panel 30 that includes thirty-six (36) discrete reflectors 32 positioned in a six by six pattern. In other embodiments, the reflector panel 30 includes forty-nine (49) discrete reflectors 32 positioned in a seven by seven pattern. It will be appreciated that in still other embodiments, the reflector panel 30 includes still other quantities and/or configurations of discrete reflectors 32.

Each discrete reflector 32 defines a top aperture 34 and a bottom aperture 36 and includes a reflective surface 38 extending between the top 34 and bottom 36 apertures. The top aperture 34 is configured to receive a discrete light source 22, such as a light emitting diode, while the bottom aperture 36 is configured to allow light from the light source 22 to travel away from the light source 22. In some embodiments, the reflective surface 38 defines a frustoconical shape extending from the bottom aperture 36 towards the light source 22. In some such embodiments, the frustoconical shape defines a 130 degree vertex angle. It will be appreciated that in other embodiments, the reflective surface 38 defines other shapes and/or defines different vertex angles.

In some embodiments, each light source 22 is coupled to a light panel 20 and the light panel 20 is coupled to the reflective panel 30. In this way, each light source 22 is capable of being positioned relative to a respective reflector 32 without requiring each light source 22 to be coupled directly to its respective reflector 32. In some such embodiments, the light panel 20 is a circuit board connecting each light source to a power source. In other such embodiments, the light fixture 10 includes wiring electrically connecting each light source 22 to a power source, such as a power converter 70.

A heat sink 40 is coupled to a back side of each light fixture 10. In some embodiments, the heat sink 40 includes a first piece 42 and a second piece 44. The first piece 42 includes a tongue on a second edge while the second piece 44 includes a groove on a first edge. The tongue of the first piece 42 is configured to slide into the groove of the second piece 44 so as to secure the first 42 and second 44 pieces together. In this way, each piece has a lower profile than would a one-piece heat sink, thereby saving tooling costs so as to reduce the overall cost of the light fixture.

In some embodiments of a heat sink 40, the first piece 42 also includes a groove on a first edge and the second piece 44 also includes a tongue on the second edge. In this way, a heat sink from a first light fixture can be coupled to a heat sink from a second light fixture in much the same way as the first piece of the heat sink is coupled to the second piece of the heat sink.

In some embodiments, a lens 28 is coupled to a front side of each light fixture. The lens is at least partially translucent and/or transparent such that at least some of the light emitted from the light sources 22 is visible through the lens 28.

In some embodiments, each light fixture provides 6,000 lumen of light while requiring less than ninety (90) watts of electricity. By coupling two light fixtures together, the module lighting system provides 12,000 lumen of light. Similarly, by coupling six light fixtures together, the module lighting system provides 36,000 lumen of light. As will be appreciated, virtually any number of light fixtures are capable of being coupled together to provide an ever-increasing amount of light. In some such embodiments, each light fixture includes its own independent power source, such as a power converter. Consequently, no matter how many light fixtures are coupled together, none of the light fixtures require the more rigorous certification process required of other high-bay lighting fixtures of the prior art because each of the light fixtures of the present invention require less than ninety (90) watts of electricity.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A light fixture comprising:
opposed first and second ends, said second end being configured to selectively couple to a first end of a second light fixture such that a plurality of electrically independent light fixtures can be coupled together in a first run of light fixtures;
a reflector panel positioned between said first and second ends, said reflector panel having a plurality of reflectors, each reflector defining a top aperture and a bottom aperture and having a reflective surface extending between said top and bottom apertures; and
a plurality of light sources, each light source being associated with a different reflector such that at least some light emitting from each light source is directed generally downward through said bottom aperture of said respective reflector,
wherein the electrical requirements of each light fixture allows the light fixture to be categorized in a second class of light fixtures, and
wherein the electrical requirements of the first run of light fixtures would cause the first run of light fixtures to be categorized in a first class of light fixtures if the light fixtures were not electrically independent of each other.

2. The light fixture of claim 1, wherein light fixtures that are categorized in the first class of light fixtures require more extensive certification testing than do light fixtures that are categorized in the second class of light fixtures.

3. The light fixture of claim 1, further comprising a heat sink coupled to a back side of the light fixture, the heat sink comprising:
a first piece extending from said first end of the light fixture towards said second end of the light fixture; and
a second piece extending between said first piece of said heat sink and said second end of the light fixture,
wherein said first piece includes a tongue and said second piece includes a groove, said tongue of said first piece being configured to slide into said groove of said second piece so as to secure said first and second pieces together.

4. The light fixture of claim 3, wherein said first piece further includes a groove and said second piece further includes a tongue such that said heat sink of the light fixture is configured to selectively couple to a heat sink of a second light fixture when a plurality of electrically independent light fixtures are coupled together in a first run of light fixtures.

5. The light fixture of claim 1, further comprising a third end extending between said first and second ends such that a plurality of third ends of a plurality of light fixtures define a third edge of a first run of light fixtures when the plurality of light fixtures are coupled together in a first run of light fixtures.

6. The light fixture of claim 5, further comprising an end cap coupled to said third end of the light fixture, the end cap defining a front aperture, a rear aperture, and an interior area extending between said front and rear apertures such that a plurality of interior areas of end caps define a raceway extending along the third edge of the first run of light fixtures when each end cap is coupled to a different third end of a light fixture of the first run of light fixtures.

7. The light fixture of claim 6, further comprising an end cap cover coupled to said end cap so as to conceal the interior area of the end cap.

8. The light fixture of claim 5, further comprising a fourth end extending between said first and second ends such that a plurality of fourth ends of a plurality of light fixtures define a fourth edge of a first run of light fixtures when the plurality of light fixtures are coupled together in a first run of light fixtures.

9. The light fixture of claim 8, wherein the fourth end of the light fixture is opposed to said third end of said light fixture.

10. The light fixture of claim 8, further comprising an end cap coupled to said fourth end of the light fixture, the end cap defining a front aperture, a rear aperture, and an interior area extending between said front and rear apertures such that a plurality of interior areas of end caps define a raceway extending along the fourth edge of the first run of light fixtures when each end cap is coupled to a different fourth end of a light fixture of the first run of light fixtures.

11. The light fixture of claim 10, further comprising an end cap cover coupled to said end cap so as to conceal the interior area of the end cap.

12. The light fixture of claim 8, wherein said third end of the light fixture is configured to selectively couple to a fourth end of another light fixture such that a third edge of a first run of light fixtures is configured to selectively couple to a fourth edge of a second run of light fixtures.

13. The light fixture of claim 12 further comprising an end cap coupled to said fourth end of the light fixture when the light fixture is part of a first run of light fixtures, the end cap defining a front aperture, a rear aperture, and an interior area extending between said front and rear apertures such that a plurality of interior areas of end caps define a raceway extending along the fourth edge of the first run of light fixtures when each end cap is coupled to a different fourth end of a light fixture of the first run of light fixtures.

14. The light fixture of claim 13, further comprising an end cap cover coupled to said end cap so as to conceal the interior area of the end cap.

15. A method of providing lighting, the method comprising:
acquiring a plurality of light fixtures;
selectively coupling a plurality of light fixtures together so as to create a first run of light fixtures; and
electrically powering each light fixture so as to cause the light fixtures to emit lighting,
wherein the electrical requirements of each light fixture allows the light fixture to be categorized in a second class of light fixtures, and
wherein the electrical requirements of the first run of light fixtures would cause the first run of light fixtures to be categorized in a first class of light fixtures if the light fixtures were not electrically independent of each other.

16. The method of claim 15, wherein light fixtures that are categorized in the first class of light fixtures require more extensive certification testing than do light fixtures that are categorized in the second class of light fixtures.

17. The method of claim 15, further comprising:
selectively coupling additional light fixtures together in a second run of light fixtures; and
selectively coupling the second run of light fixtures to the first run of light fixtures.

18. The method of claim 17, wherein the first run of light fixtures includes more light fixtures than does the second run of light fixtures.

19. The method of claim 18, further comprising:
selectively coupling additional light fixtures together in a third run of light fixtures; and
selectively coupling the third run of light fixtures to the second run of light fixtures.
